(19) United States
(12) Patent Application Publication
(10) Pub. No.: US 2015/0163989 A1
(43) Pub. Date: Jun. 18, 2015

(54) AGRICULTURAL IMPLEMENTS WITH HINGED AND FLOATING WINGS

(71) Applicant: Landoll Corporation, Marysville, KS (US)

(72) Inventors: Donald R. Landoll, Marysville, KS (US); Phillip R. Landoll, Marysville, KS (US); Christopher Lee Tamm, Brillion, WI (US); Richard W. Penner, Beatrice, NE (US)

(21) Appl. No.: 14/630,568

(22) Filed: Feb. 24, 2015

Related U.S. Application Data
(63) Continuation-in-part of application No. 13/915,488, filed on Jun. 11, 2013, now Pat. No. 8,960,321.
Application No. 13/915,488 is a continuation-in-part of application No. 13/401,825, filed on Feb. 21, 2012, now abandoned.
Application No. 13/401,825 is a continuation of application No. 12/387,935, filed on May 8, 2009, now Pat. No. 8,118,110.

(51) Int. Cl. A01B 73/04

(52) U.S. Cl. CPC A01B 73/044

(57) ABSTRACT

A towable agricultural implement having a center section and foldable wings mounted by hinges on opposite sides of the center section to fold upwardly or downwardly about substantially longitudinal hinge axes. Each hinge has a spaced ball joint and guide roller in roller slot. A wing float axis for each wing extends substantially perpendicular to the longitudinal hinge axis in a transverse direction, each wing also being pivotal about the float axis. The hinge design with the float axis prevents weight transfer between the center section and wing sections when the implement operates over uneven soil, providing uniform soil conditioning over the width of the implement. The center section rollers are positioned ahead of, behind, or co-linear with the wing rollers. Lockout kits are provided for mounting within the roller guide slots for restricting motion.

### CROSS-REFERENCE TO RELATED APPLICATIONS

This application is a continuation-in-part of and claims priority in U.S. patent application Ser. No. 13/915,488, filed Jun. 11, 2013, now U.S. Pat. No. 8,960,321, issued Feb. 24, 2015, which is a continuation-in-part of and claims priority in U.S. patent application Ser. No. 13/401,825, filed Feb. 21, 2012, now abandoned, which is a continuation of and claims priority in U.S. patent application Ser. No. 12/387,935, filed May 8, 2009, now U.S. Pat. No. 8,118,110, issued Feb. 21, 2012, all of which are incorporated herein by reference.

### BACKGROUND OF THE INVENTION

1. Field of the Invention

The present invention relates to a towable agricultural implement, such as a soil pulverizer, which has a center section and foldable wing sections mounted on opposite sides of the center section. The wings of the towable agricultural implement are unfolded when working the ground and are folded when transporting the implement, e.g., between fields.

2. Description of the Related Art

Agricultural implements are used by farmers during planting season to help prepare an ideal seedbed. Since yield is a direct result of germination, which is dependent on soil conditions at planting time, having an ideal seedbed is desired. Agricultural implements can be used to break up clods and insure good seed to soil contact, reducing germination time. Since the seedbed is firmed and air pockets are eliminated, capillary action in the soil is also increased, making more moisture available to the plants through their roots for enhanced growth and crop yields.

As fields become larger and individual farms cover more acres, equipment has become larger to cover more land in less time. One way to cover more land is to make machinery wider, but with that comes the problem of transporting it from field to field. Wide machinery is typically folded for transport on public roadways. Inherent to a folding piece of machinery is to have a hinge point, e.g., between the wings and the center section.

FIG. 1, for example, shows a conventionally hinged pulverizer 10 having a drawbar 11 for attaching at one end 12 to a tractor (not shown) for towing the pulverizer. Drawbar 11 is attached at its other end to pulverizer center section 13. Center section 13 includes ground engaging roller wheels 14 constituting the center roller, transport wheels/rockshaft assembly 15, and hinge points 16, 17. Wing roller assemblies 18 with ground engaging roller wheels 19 extend transversely on opposite sides of center section 13 and are fairly rigidly connected to center section 13 at the hinge points 16, 17 respectively. When the pulverizer 10 is to be transported, wing assemblies 18 are folded about hinge points 16, 17 to a position shown, for example, in FIG. 2. A double acting hydraulic cylinder (not shown) on the center section acts to initiate and carry out the folding. Wing hinges 24 at hinge points 16, 17 connect the wing assemblies 18 to the center section 13 of the pulverizer by conventional means of a hinge pin 20 and center section hinge plates and barrel 21, shown in FIG. 6 just prior to connection.

As described above, an agricultural implement, parts and hinge connections for the wings are all well known in the prior art. However, a difficulty with this design is that when the implement is operational and towed over fields that are not perfectly level, the height of drawbar 11 varies and weight distribution and the depth control of the ground engaging components are both affected by varying drawbar heights (due to ground contours), ground contours at the rollers, and ground obstructions (e.g., rock outcroppings, tree stumps, etc.) on the winged pulverizer. It is common in pulverizers for the wing rollers 19 to be set back from the center rollers 14 to provide some overlap, ensuring that over the total width of the pulverizer there are no strips of unconditioned soil. The varying drawbar heights come into consideration because the wing rollers are not in line with the center section rollers. More specifically, FIGS. 3-5 illustrate the effects of this design. In FIG. 3, the conventionally hinged pulverizer (shown from the left side) is being towed toward the left, i.e., down from the top of a ground contour 25. Shown in exaggerated form, the weight of the center section is transferred to the wing rollers 19 and the center section rollers 14 tend to be lifted off the ground. In FIG. 4, a view towards the rear of the conventionally hinged machine of FIG. 3, the weight of the center section transferred to the wings causes them to lift at their outer extremities. Since the wings are allowed to flex about the hinge points, the wing rollers closest to the hinge now have to carry both the weight of the center section and the weight of the wings lifted off the ground, resulting in a poorly conditioned seed bed. As again viewed from the left side of the pulverizer, FIG. 5 shows what typically happens from the scenario of FIGS. 3 and 4. The center section is heavier than the wings due to the weight of the transport wheels/rockshaft assembly and the drawbar causing a reaction resulting in the wings picking up at the extremity to a point where the weight carried by the center section is balanced by the weight carried on the wings. Ground contact is limited on the wing rollers 19, the center section conditioning is limited due to the reduced weight on the center section rollers 14, and the wing roller portions nearest the hinge are forced to carry extra weight that may cause a packed groove in the soil.

In short, with the current conventionally hinged design, weight from the wings is transferred to the center section or vice versa. When this happens, portions of the wings or center section are not engaging the soil, making for inconsistent conditioning. Also, since weight transfer takes place, the rollers in contact with the soil have to carry extra weight, which gives the possibility of those rollers sinking into the ground and pushing the soil rather than rolling over the top of the soil, or packing the soil making it more difficult for germinating seeds and plants to break through. The conventional hinge design of FIG. 6 allows the wings to fold over the top of the center section, but does not allow any freedom for the wings to maintain uniform ground control as the drawbar height changes, causing the machine to rock about the center section rollers.

Attempts have been made in the past to deal with farm machines operating on uneven ground. See, for example, U.S. Pat. No. 93,959 involving the connection of two harrows operating side by side to form a double harrow. The side of a first harrow adjacent its longitudinal ends has two hoops, and the side of a second harrow adjacent its longitudinal ends has two arms to fit within the corresponding two hoops in the first harrow when the second harrow is positioned at a right angle to the first harrow. There is no center section between the two harrows which are positioned side by side, and no folding rotation between the two harrows. Each frame can move up and down or back and forth with respect to the other to a limited extent to provide a limited independent movement over uneven ground. There is no hinge or joint connection between the two frames. Each harrow frame has a separate chain draught connection for the protection and comfort of the towing horses. Among other deficiencies, the design of the '959 patent does not lend itself to solving the above-described difficulties of the conventionally hinged pulverizer having a drawbar, a center section with rollers, and the center section rollers positioned forward of folding-wing rollers.

Further, see for example U.S. Pat. No. 6,325,155 involving a design having a center frame and opposing double wings of inner and outer wing sections which are intended to follow ground elevation. A linkage allows the inner wings to move perpendicular to the center section, and there is a draft cable to help distribute the draft load generated by the outer wings. A universal joint having three axes of freedom connects the inner wing sections to the center section. A differential control rod parallel to the center section is required and which controls the universal joint. An “L”-shaped linkage controls the movement of a pivot in a slot, the linkage being pivotally attached to the center frame and differential control bar. The center frame and universal joint are rotated ninety degrees in passing between the transport and field operational modes. The wings fold rearwardly into the transport mode. Altogether, this three-axis arrangement of parts and motions is overly complex for the needs satisfied by applicant's invention involving a considerably simpler structure and functioning.

In light or loose soil conditions, it can be difficult to maintain constant depth across the entire width of a towable soil pulverizer. In such conditions, the wings of the implement may sink or rise depending on the soil. A float-restricting lockout kit may be installed in new or existing implements, which prevents the wings of the implement from bowing or lifting, thereby establishing uniform depth throughout the soil being worked.

### SUMMARY OF THE INVENTION

The present invention is intended to avoid the above-discussed difficulties of conventionally hinged agricultural implements. The proposed new design focuses on the hinge area of the winged implement and allows the wings to act independently of the center section as if the center section and opposing wing sections were three separate implements being towed but integrated into a single machine. All three sections can follow the contour of the soil surface and uniform conditioning of the soil can thus be obtained, contours or not. An aspect of the new design utilizes a similar pulverizer center section and foldable wings on opposite sides of the center section. The wing rollers are placed rearwardly of the center section rollers, and a new simple hinge design is applied. The center section rollers may also be placed behind or co-linear with the wing rollers. Folding is not affected with the new design, and the wings are still folded upwardly and over the top by the well-known double acting hydraulic cylinder and associated components. However, another degree of limited freedom is added to the machine to apply a limited floating action to the wings.

More specifically, the hinge between each wing and the center section includes a ball joint adjacent one end of the hinge, and a guide roller in a roller slot adjacent the other end of the hinge. Certain components of the hinge, i.e., the ball of the ball joint and the roller slot, are non-rotationally and fixedly attached to the center section. The hinge axis extends substantially in a longitudinal direction from front to rear of the center section and passes through the ball joint and the guide roller. The terms “longitudinal” and “longitudinal hinge axis” as used herein are intended to include a few degrees variation sideways from true longitudinal to allow folding of the wings without interfering with each other as shown in FIG. 2; as well as a few degrees up and down from true longitudinal as the guide roller moves up or down in the guide roller slot. The ball joint and the roller in the roller slot allow the wing to be folded up over the center section. Further, the ball joint and guide roller in roller slot allow a floating action of the wing about a further “float” axis perpendicular to the hinge axis to a degree determined by the depth of the roller slot. The hinge pin and hinge plates/barrels of the conventionally hinged pulverizer are eliminated. The floating action provided prevents the undesirable weight transfer from the wing sections to the center section and vice versa, through the designated range of floating provided by the new hinge design. The implement thus is now able to conform to the contour of the soil to ensure that uniform conditioning takes place across the entire width of the machine. A further feature of the design is that if an obstacle such as a stone is encountered while in use, the section that rolls over the stone does not affect the rest of the machine since there is no weight transfer between sections.

It should also be noted that the new hinge design allows the implement to be backed up in a field without the wings interfering when in the operating position.

An alternative embodiment implement includes a float-restricting lockout kit which may be installed where the floating wings are connected to the central portion of the implement. This lockout kit prevents the wing or the central portion from sinking in loose or light soil conditions. Essentially, the separate implement sections effectively stabilize the other sections. When the lockout kit is in place, the wings lose their ability to “float.”

In alternative embodiments, the ball joints, guide roller slots, and guide rollers can be applied to other types of agricultural implements, allowing for floating wing sections. One such embodiment is an implement mounting two rows of Coulter discs and a row of conditioning reels, or cylinders, with its wing sections lined up with its center section.

In an exemplary embodiment, floating wing sections are applied to a high speed tillage implement. An example of such a high speed tillage implement is described in U.S. Patent Application Publication No. 2014/0262368 A1, entitled “HIGH SPEED TILLAGE TOOL AND METHOD OF USE,” which application is incorporated by reference.

In another exemplary embodiment, floating wing sections are applied to an implement having tandem conditioning reels. An example of such an implement having tandem conditioning reels is described in U.S. Patent Application Publication No. 2014/0262379 A1, entitled “TANDEM CONDITIONING REELS FOR CULTIVATOR WITH BEARING SYSTEM,” which application is incorporated by reference.

In another exemplary embodiment, floating wing sections are applied to an implement having tillage disc assemblies. An example of such an implement having tillage disc assemblies is described in U.S. Patent Application Publication No. 2014/0262373 A1, entitled “TILLAGE DISC ASSEMBLIES,” which application is incorporated by reference.

Other features and advantages of the present invention will be apparent from the following description, drawings and claims.

### BRIEF DESCRIPTION OF THE DRAWINGS

The drawings constitute a part of this specification and include exemplary embodiments of the disclosed subject matter illustrating various objects and features thereof.

FIG. 1 is a perspective view of a conventionally hinged pulverizer with a center section and unfolded wing sections. Parts not essential to a discussion of the background and substance of the present invention are not shown.

FIG. 2 is a perspective view of the conventionally hinged pulverizer of FIG. 1, but with the wings folded upward and over the center section for transport of the pulverizer.

FIG. 3 is a left side elevation of the pulverizer of FIG. 1 showing a particular operating tendency with the conventional hinge and unfolded wings.

FIG. 4 is a rear view of the conventionally hinged pulverizer of FIG. 1 under the operating tendency of FIG. 3.

FIG. 5 is a left side elevation of the pulverizer of FIG. 1 showing the operating scenario that results from the FIGS. 3 and 4 operating tendencies.

FIG. 6 is a perspective view of the conventional hinge components for the pulverizer of FIGS. 1-5.

FIG. 7 is a perspective view corresponding to FIG. 1 of a pulverizer utilizing the present invention.

FIG. 8 is a perspective view of the new design of the components of the present invention to provide the desired hinged and floating wings.

FIG. 9 is a rear view of the pulverizer of FIG. 7 (but showing only one wing) and illustrating a first wing floating operational scenario.

FIG. 10 is a rear view of the pulverizer of FIG. 7 (but showing only one wing) and illustrating a second wing floating operational scenario.

FIG. 11 is a right side elevation of the pulverizer of the present invention, in operational position and illustrating the guide roller at the bottom of the guide roller slot.

FIG. 12 is a right side elevation of the pulverizer of the present invention, in operational position and illustrating the guide roller several inches up from the bottom of the guide roller slot.

FIG. 13 is a right side elevation of the pulverizer of the present invention, in operational position and illustrating the guide roller raised to the top of the guide roller slot.

FIG. 14 is an isometric perspective view of a float restricting lockout kit which may be installed on an implement embodying the previous embodiment.

FIG. 15 is an exploded isometric perspective view showing the float restricting lockout kit of FIG. 14.

FIG. 16 is a rear elevation of a pulverizer including a floating wing on an even surface.

FIG. 17 is a rear elevation of a pulverizer including a floating wing, wherein the wing is positioned on light or loose soil.

FIG. 18 is a rear elevation of a pulverizer including a floating wing, wherein the central portion of the pulverizer is positioned on light or loose soil.

FIG. 19 is a rear elevation of an alternative embodiment pulverizer utilizing the float restricting lockout kit of FIGS. 14 and 15.

FIG. 20 is a detailed front elevation taken generally within Circle 20 in FIG. 19, showing an embodiment of the float restricting lockout kit installed in a pulverizer wing joint.

FIG. 21 is a side elevation of the float restricting lockout kit.

FIG. 22 is a perspective view of a pulverizer comprising a modified aspect or embodiment of the present invention, shown in a field working configuration.

FIG. 23 is a perspective view of the modified aspect or embodiment pulverizer, shown in a folded transport configuration.

FIG. 24 is a top, plan view of an agricultural tillage implement having floating wing sections.

FIG. 25 is a front, perspective view of a ball joint of the agricultural tillage implement having floating wing sections.

FIG. 26 is a back, perspective view of a guide slot and guide roller of the agricultural tillage implement having floating wing sections.

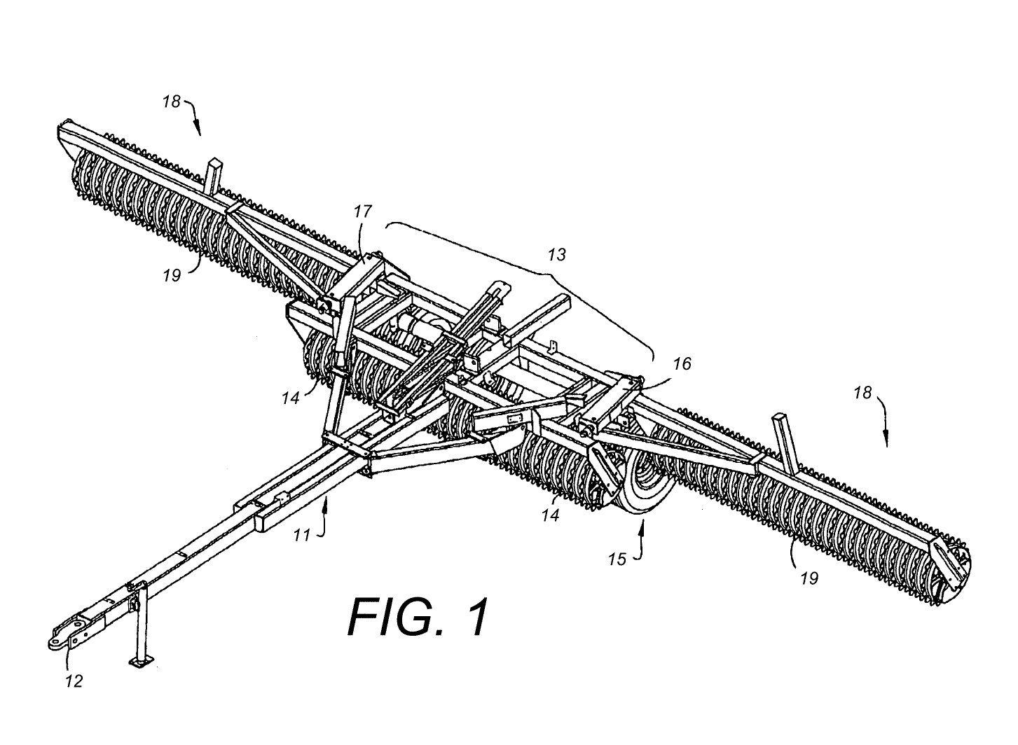

### DETAILED DESCRIPTION OF THE PREFERRED EMBODIMENTS

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Forwardly and rearwardly are generally in reference to the direction of travel, if appropriate. Said terminology will include the words specifically mentioned, derivatives thereof and words of similar meaning

II. Pulverizer with Floating Wings

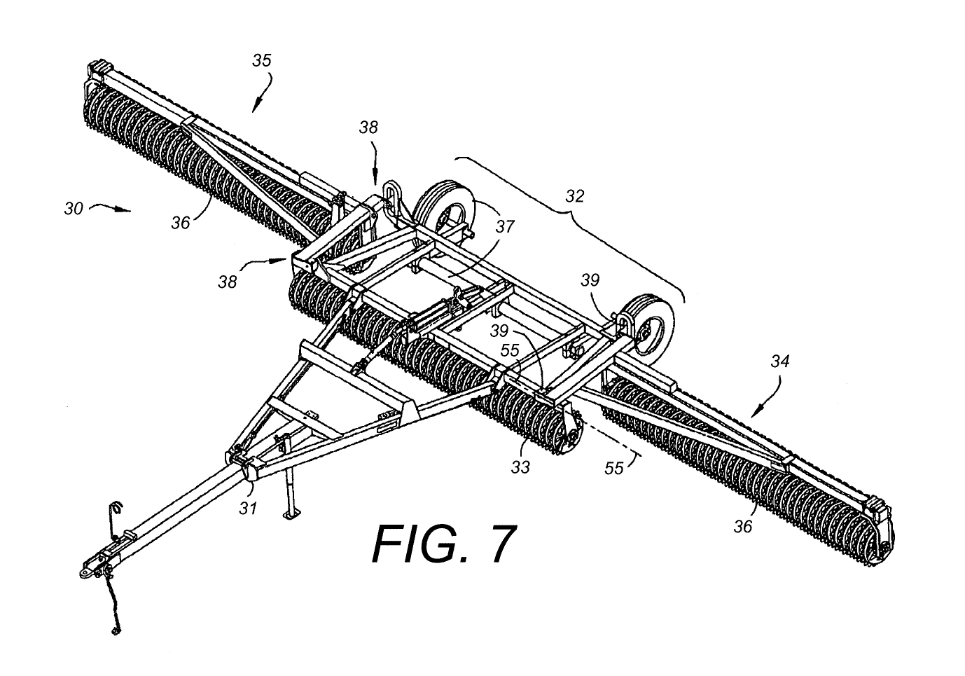

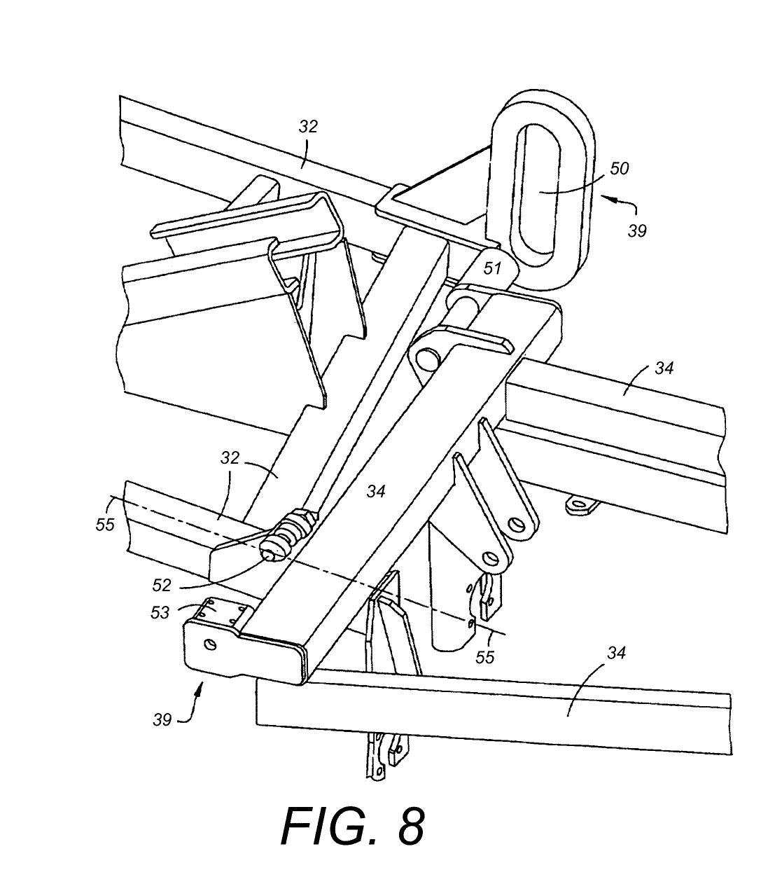

Referring to FIG. 7, the pulverizer 30 is shown assembled with drawbar 31 for towing center section frame 32 having forwardly positioned center section rollers 33, wings 34 and 35 with wing rollers 36 and the wings being unfolded and extended on opposite sides of center section 32, the transport wheels and axle and rockshaft assembly 37, and the new hinge joints 38 and 39. FIG. 8 illustrates the enlarged and exploded hinge joint 39 positioned on the side of the center section as shown in FIG. 7, there being a corresponding hinge joint 38 present on the opposite side of center section 32 to connect wing 35. The following discussion, therefore, correspondingly applies to hinge joint 38 as well.

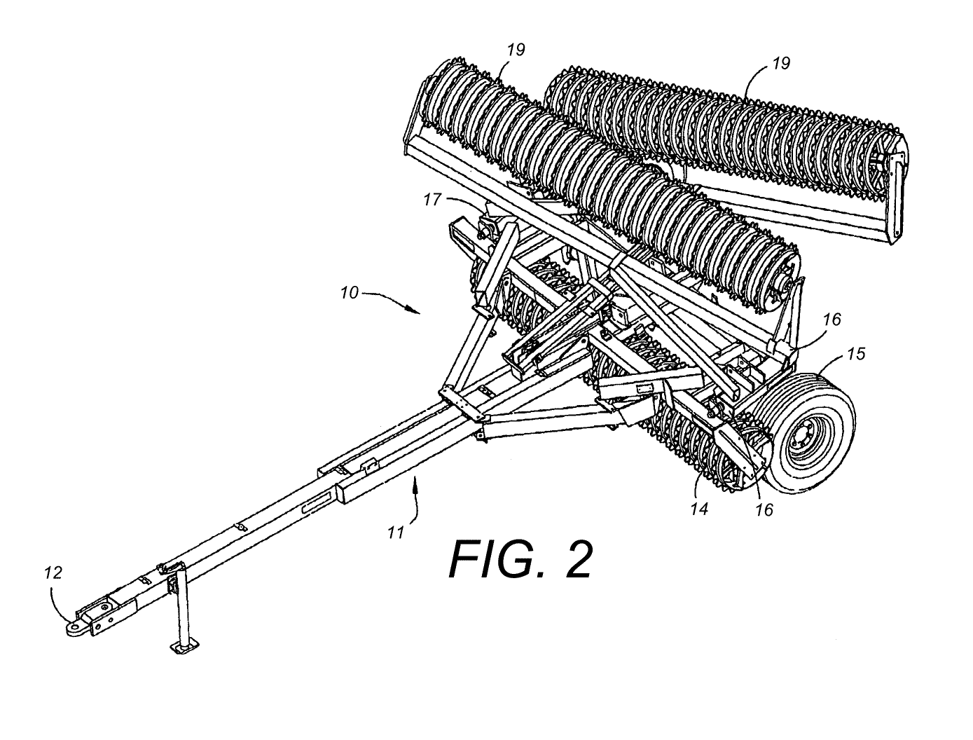

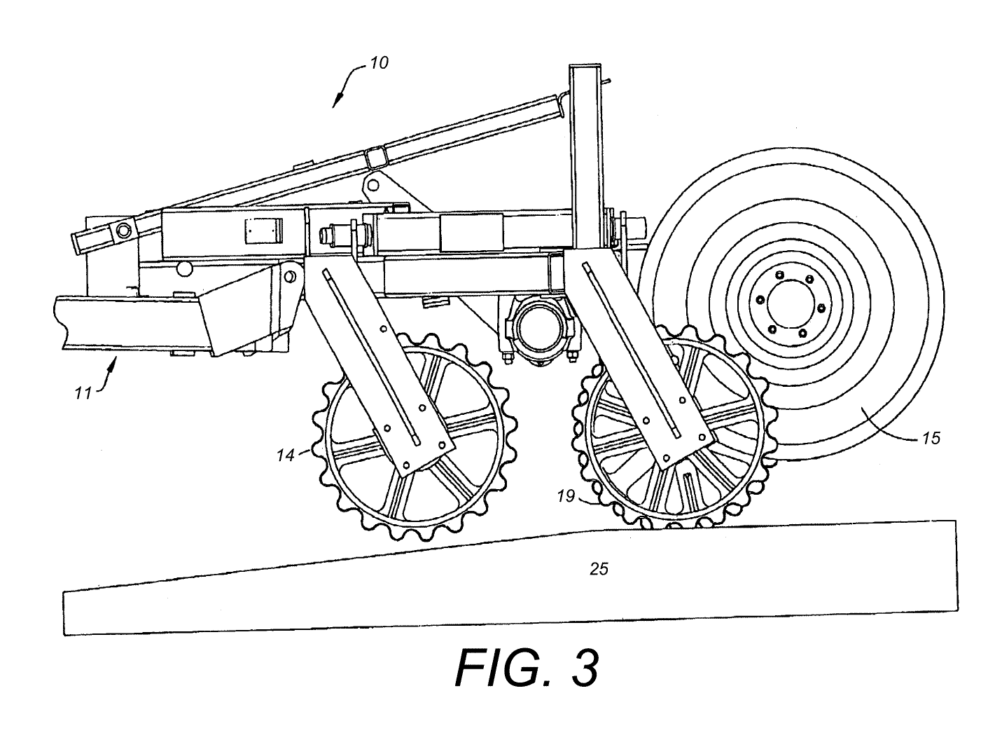

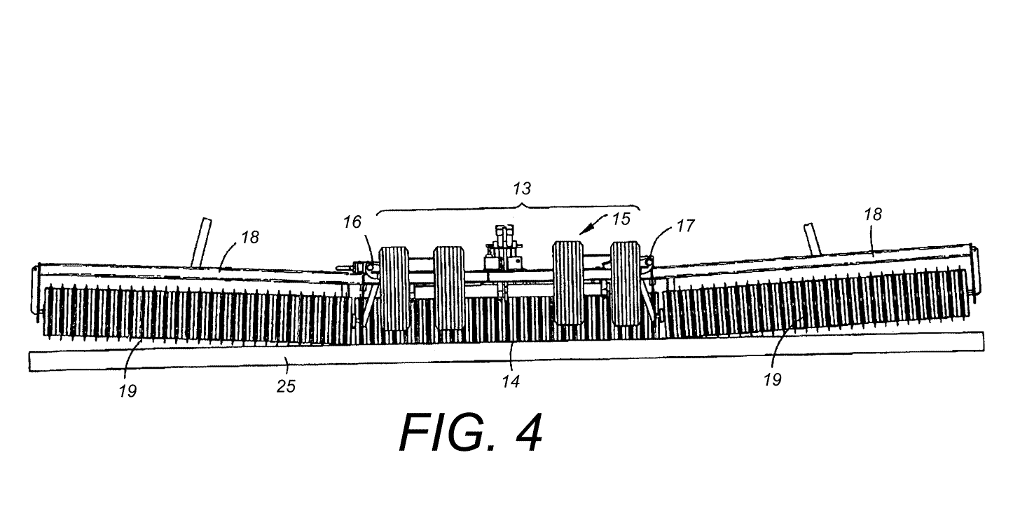

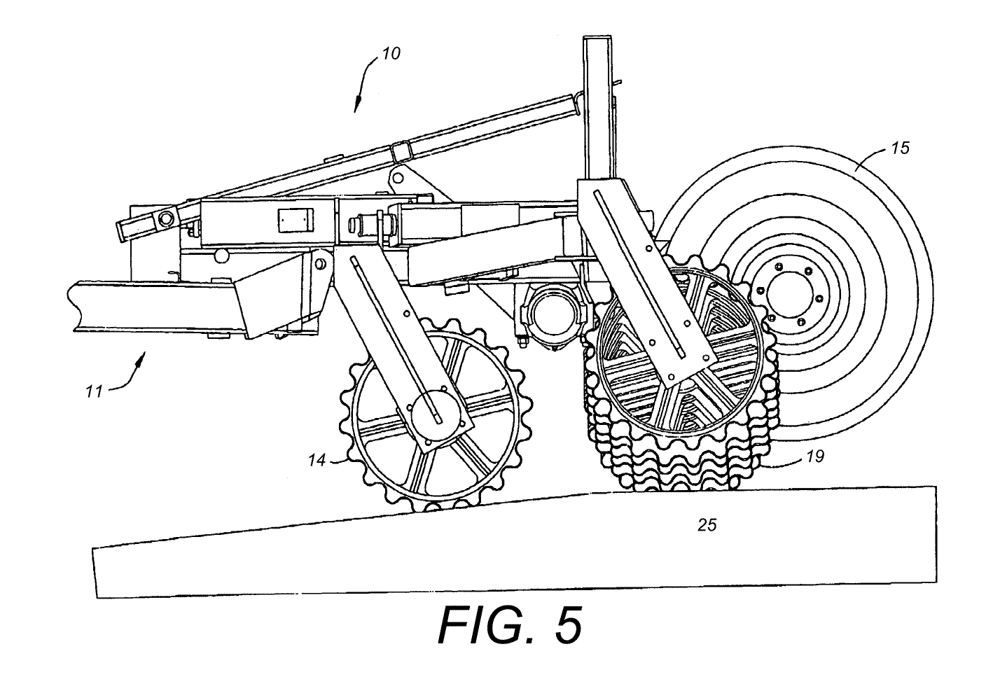

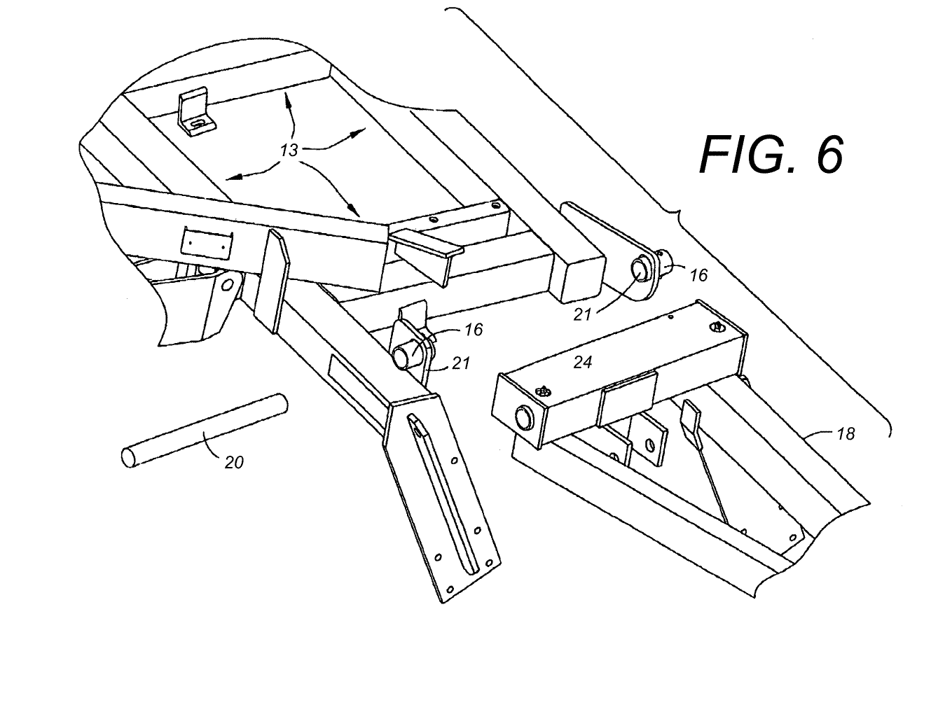

Referring to FIG. 8, the hinge joint 39 is comprised of roller slot 50 which is part of center section 32 at the outside rear of that section, guide roller 51 attached to wing 34 at its inner rear portion for mounting in roller slot 50 for up and down motion therein, ball joint ball 52 mounted on center section 32 at the outside front of that section, and ball joint socket 53 attached to the wing at its inner front portion for joining with ball 52 to form an assembled ball joint 60. The assembled ball joint, along with guide roller 51 inserted into roller slot 50, allows the wing 34 to fold up over center section 32 in the same manner as in FIG. 2, but here about a hinge “folding” axis defined by the assembled ball joint and guide roller 51.

In addition, by virtue of the combination of the ball joint and the guide roller-roller slot, wing 34 also can rotate about the ball joint to a limited degree (defined by the guide roller and roller slot) about a transverse axis through the assembled ball joint essentially perpendicular to the axis of folding. This allows the wing 34 to in effect “float” over obstacles, and this further axis is thus referred to as “float” axis 55-55. These two perpendicular axes allow two degrees of freedom for the wing to move in, and prevent weight transfer from the wings to the center section and vice versa as previously discussed as long as guide roller 51 is free to move in the ambit of roller slot 50 and is not forced against the top or bottom of the slot. The pulverizer is now able to conform to the contour of the soil, ensuring that uniform conditioning takes place along the entire width of the machine.

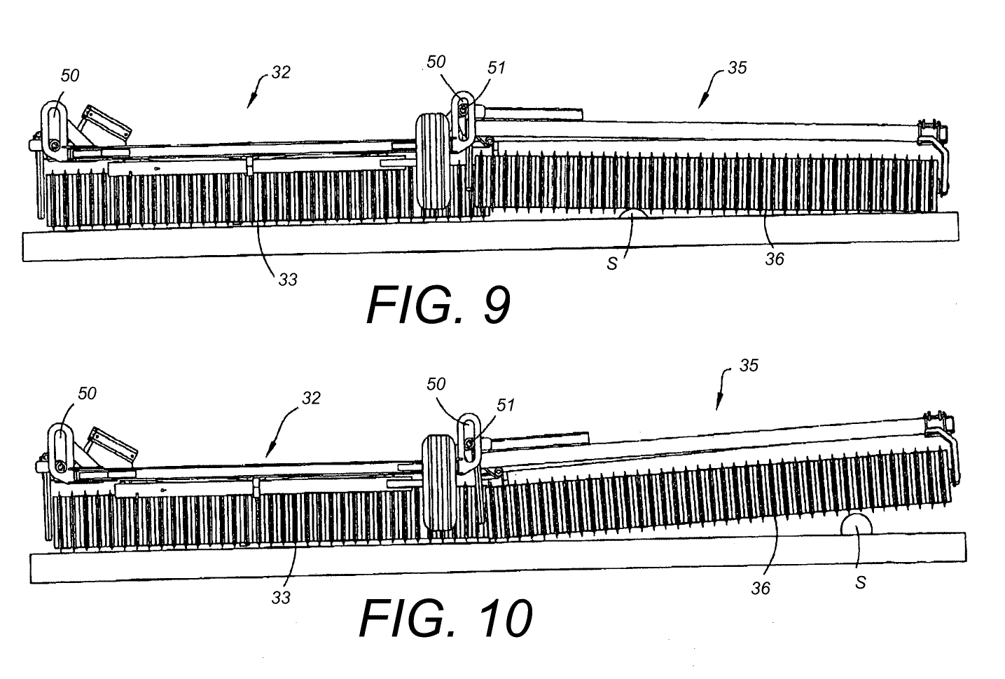

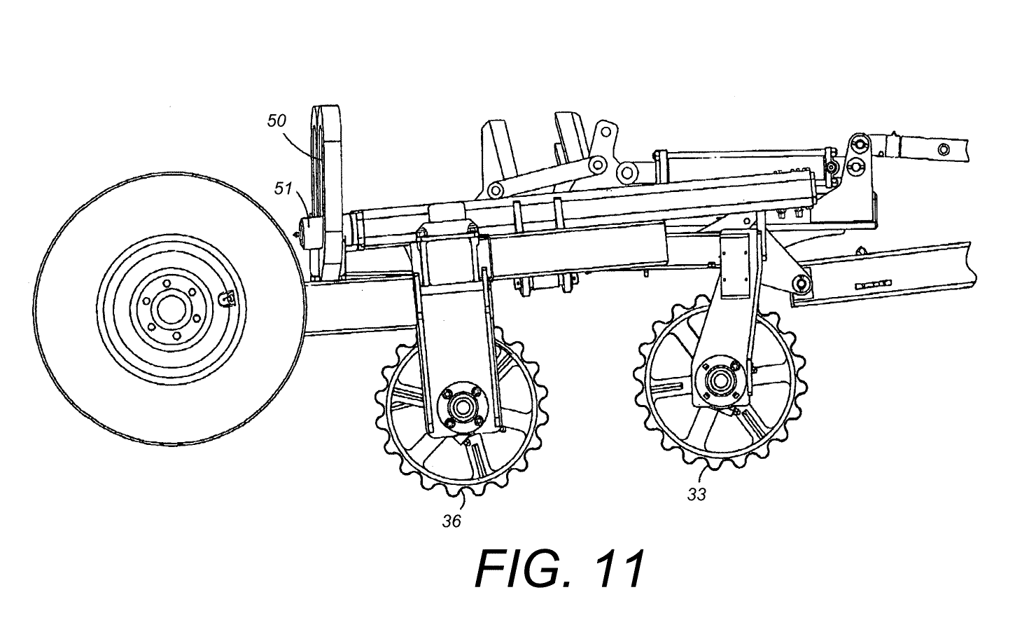

Another feature of the present invention is that if an obstacle such as a stone is encountered while in use, the section rolling over the stone does not affect the rest of the machine because of the lack of weight transfer between the sections. See, for example FIGS. 9 and 10, views from the rear of the pulverizer (left wing eliminated for ease of depiction). In each case the right wing is “floating” over an obstacle while in operation due to the ability of the guide roller to move in the roller slot and wing 35 thus able to pivot about the float axis 55-55 (FIGS. 7 and 8). In FIG. 9 the outer portion of the wing 35 is in contact with the soil surface due to the mass center of the wing being outboard of the stone S being passed over. In FIG. 10 the inner portion of the wing 35 is in contact with the soil surface due to the mass center of the wing being inboard of the stone S being passed over. In neither case is there weight transfer from the wing 35 to the center section 32 nor vice versa. In FIG. 9, the guide roller 51 has moved toward the top of roller slot 50; in FIG. 10, the guide roller 51 has moved toward the bottom of roller slot 50.

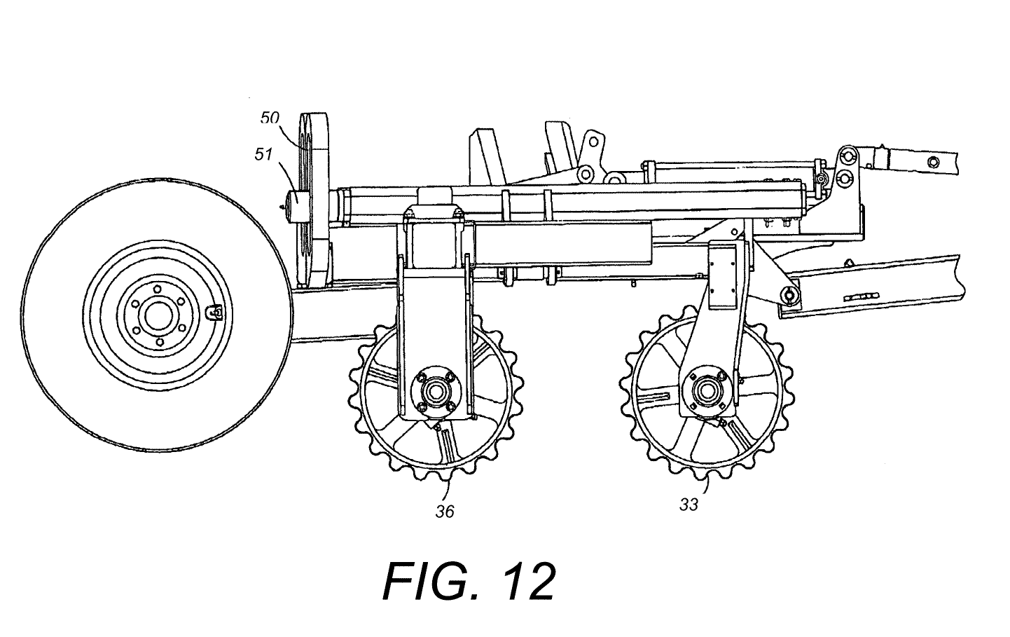

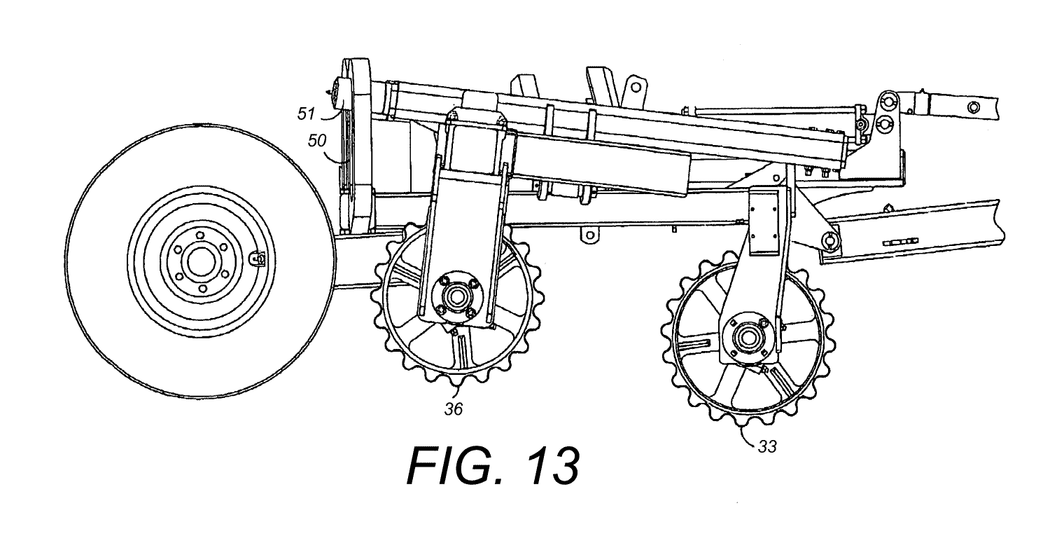

FIGS. 11-13 are right side elevational views of the pulverizer respectively showing guide roller 51 at the bottom of slot 50 (FIG. 11), guide roller 51 in the middle of slot 50 (FIG. 12) several inches from the slot bottom, and guide roller 51 at the top of slot 50 (FIG. 13) several further inches from the slot bottom. In FIGS. 11-13, the various elevations of the wing rollers 36 can be noted for the different operating conditions.

When the wings are to be folded upwardly for transport, the folding action may begin with the guide roller at the bottom of the guide slot. As a safety measure, a cam or other retaining means may then be used to move into position to hold the guide roller at the bottom of the slot during and after the folding to stabilize the wing until unfolded.

III. Alternative Embodiment or Aspect Pulverizer 202 with Lockout Kit 102

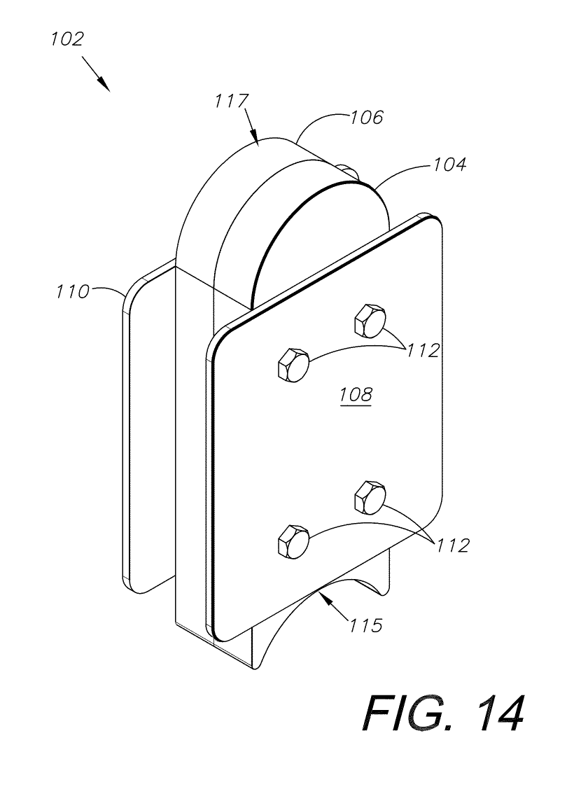

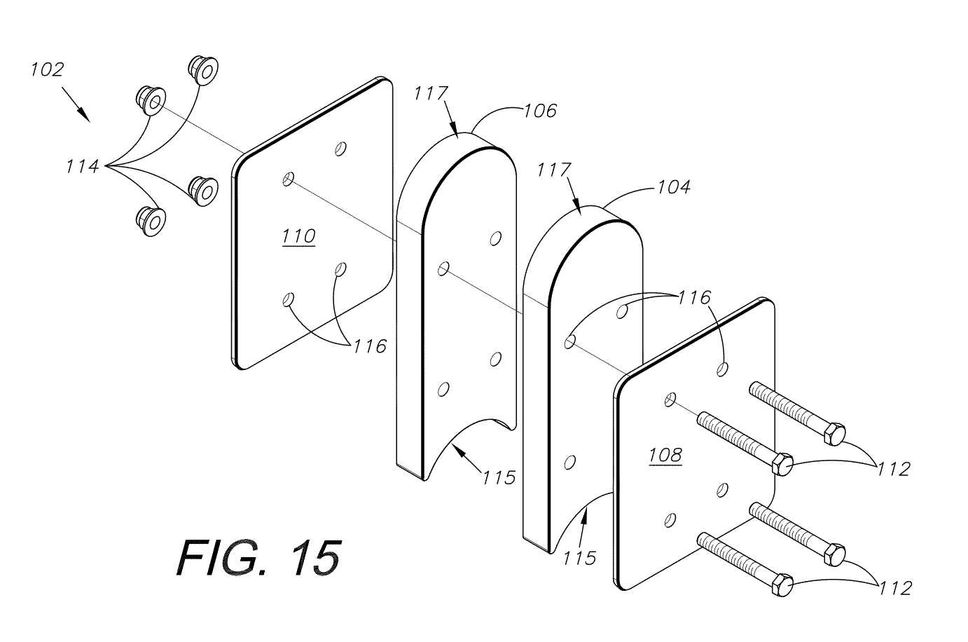

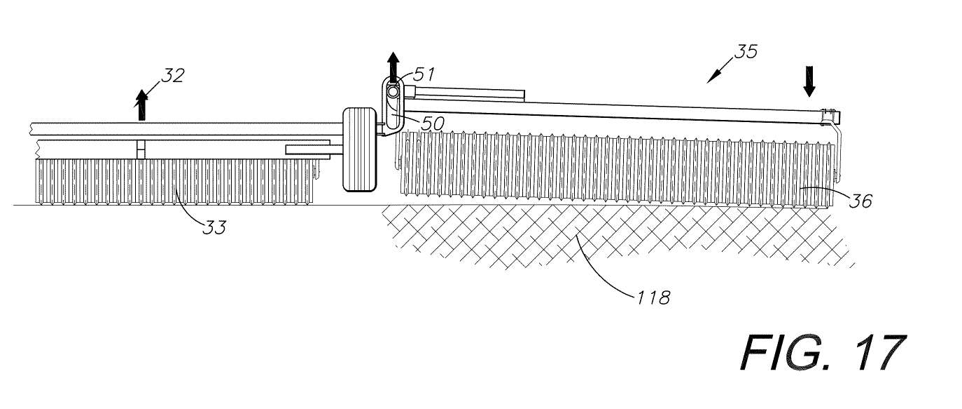

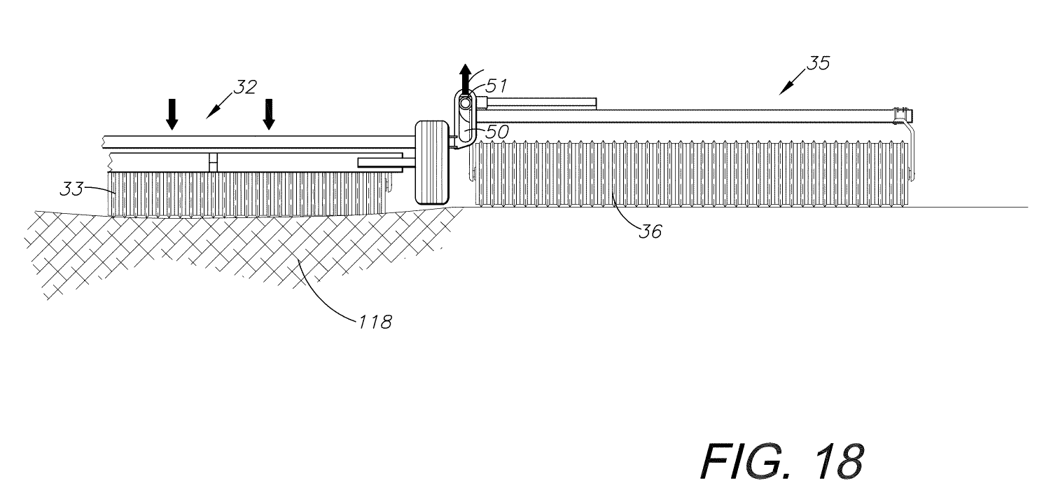

A float restricting lockout kit 102 is shown in FIGS. 14 and 15. This kit is designed to fit between the guide roller 51 of the wings 35, 36 and the roller slot 50 connected to the center portion 32 of the pulverizer 10. The purpose of the lockout kit is to restrict the wings 35, 36 from floating when the pulverizer 10 is working in loose or light soil 118. In light soil, the wings or the central portion of the pulverizer 10 may sink as shown in FIGS. 17 and 18, thereby limiting the surface area the pulverizer 10 can work. The float restricting lockout kit 102 causes the wings 34 and the center section 32 to support the other components, resulting in an evenly-worked field.

FIG. 15 shows the individual parts of the lockout kit 102 in more detail. The lockout kit 102 is comprised of a first plate 108, a second plate 110, a first wing stop 104, a second wing stop 106, and a plurality of bolts 112 and locking nuts 114. Each of these elements includes bolt holes 116 which allow the bolts 112 to join the elements together, as shown in FIG. 15.

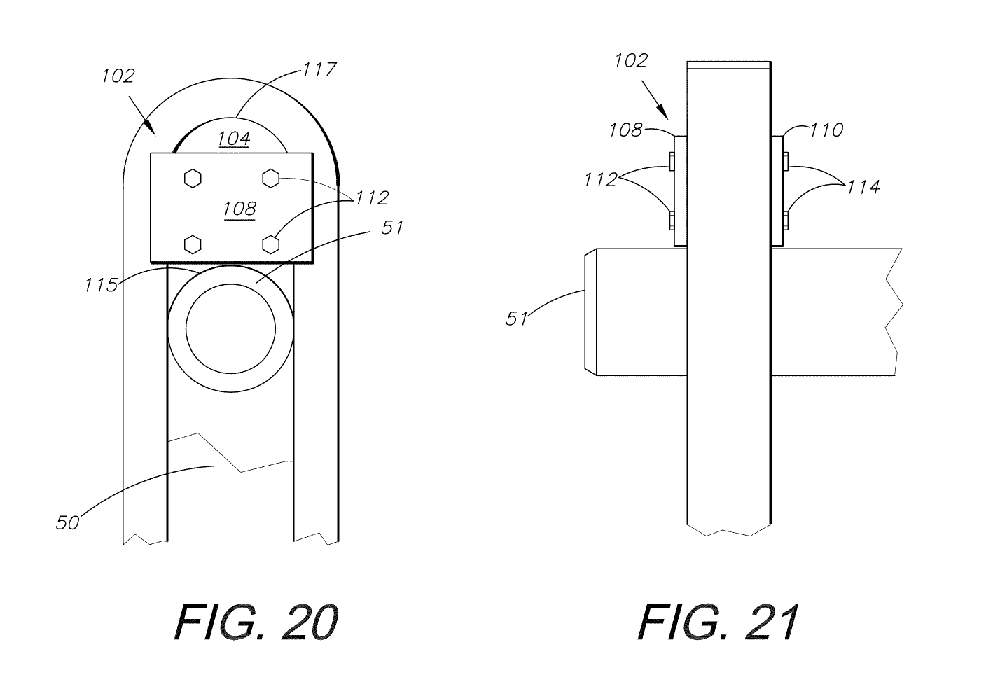

The wing stops 104, 106 are designed to fit above the guide roller 51 and within the roller slot 50. FIGS. 20 and 21 show this in more detail. These stops include an apex curve 117, which shape corresponds with the shape of the roller slot 50, and a curved seat 115, which corresponds with the shape of the guide roller 51. The stops 104, 106 are placed on top of the guide roller 51 and physically prevent the roller from moving vertically within the roller slot 50. The plates 108, 110 are affixed to the stops 104, 106, thereby preventing the stops from falling out of the roller slot 50.

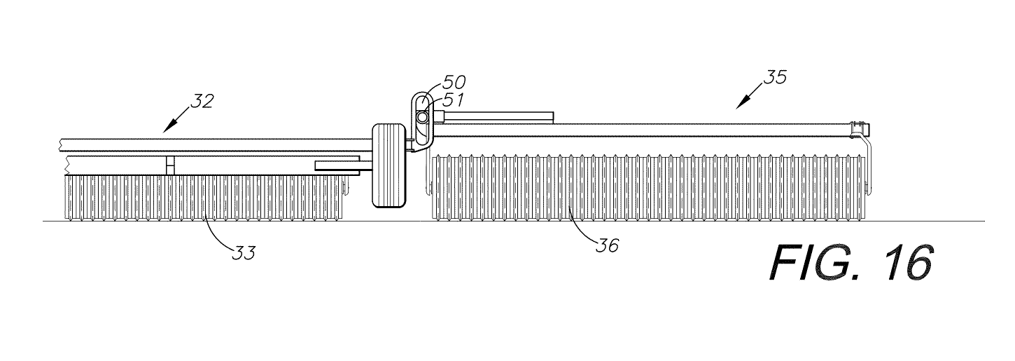

FIGS. 16 through 19 show the pulverizer 10 in varying topsoil 118 conditions. The type of soil 118 beneath the pulverizer 10 will determine whether the lockout kit 102 is necessary. FIG. 16 is a preferred soil condition wherein the wing 35 is allowed to float freely. There is no obstruction of the guide roller 51.

FIG. 17 shows a condition where the soil beneath the wing 35 is soft or loose soil 118. Here, the wing is sinking into the soil 118. This may cause the guide roller 51 to rise within the slot 50. When this happens, some of the wing rollers 36 may not contact the earth at all. Alternatively, the rollers 36 which sink may go too deeply into the earth.

A similar situation is shown in FIG. 18. Here, the central portion 32 sinks into the loose soil 118. Because the guide roller is unrestricted, the wings 35 cannot support the central portion 32 and prevent it from sinking

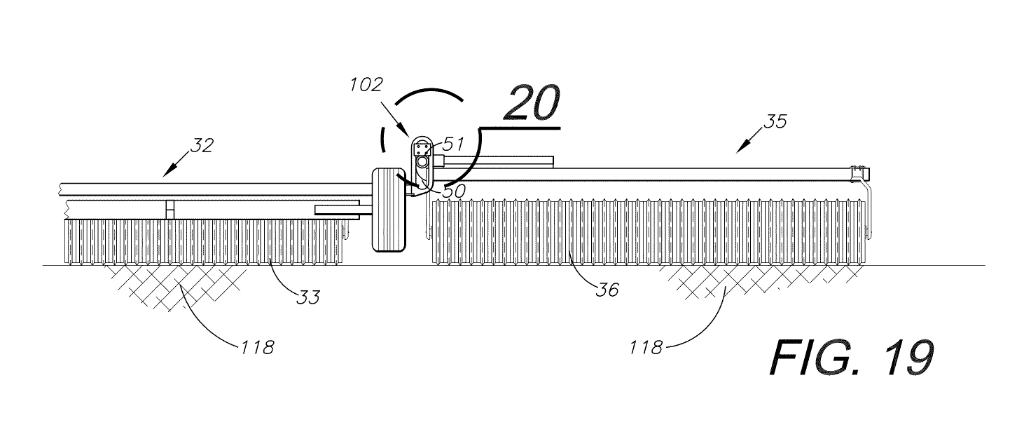

FIG. 19 shows a situation where the pulverizer is operating over loose soil 118. Here, a float-restricting lockout kit 102 is installed in the roller slot 50. The wing 35 and the central portion 32 support each other, insuring uniform distribution of the rollers 33, 36. The outer edges of the wings do not sink, and the wings 35 keep the center section 32 from sinking

As stated above, FIGS. 20 and 21 show more detail of the interaction between the lockout kit 102, the guide roller 51, and the roller slot 50. The height of the stops 104, 106 depends on the soil. It is possible to fully lock the guide roller 51 using such a kit 102.

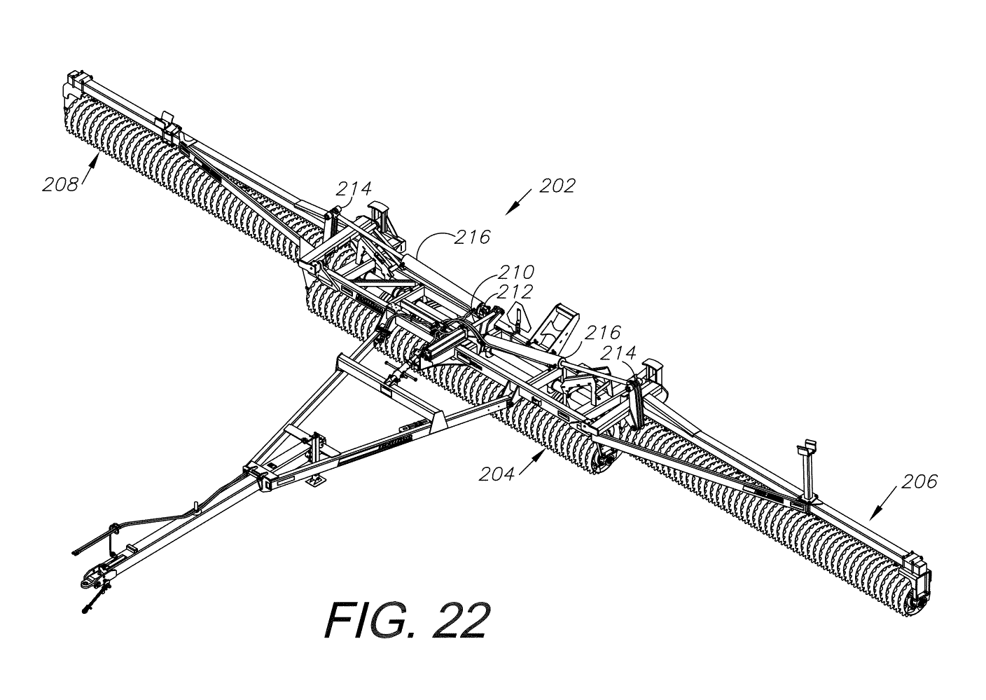

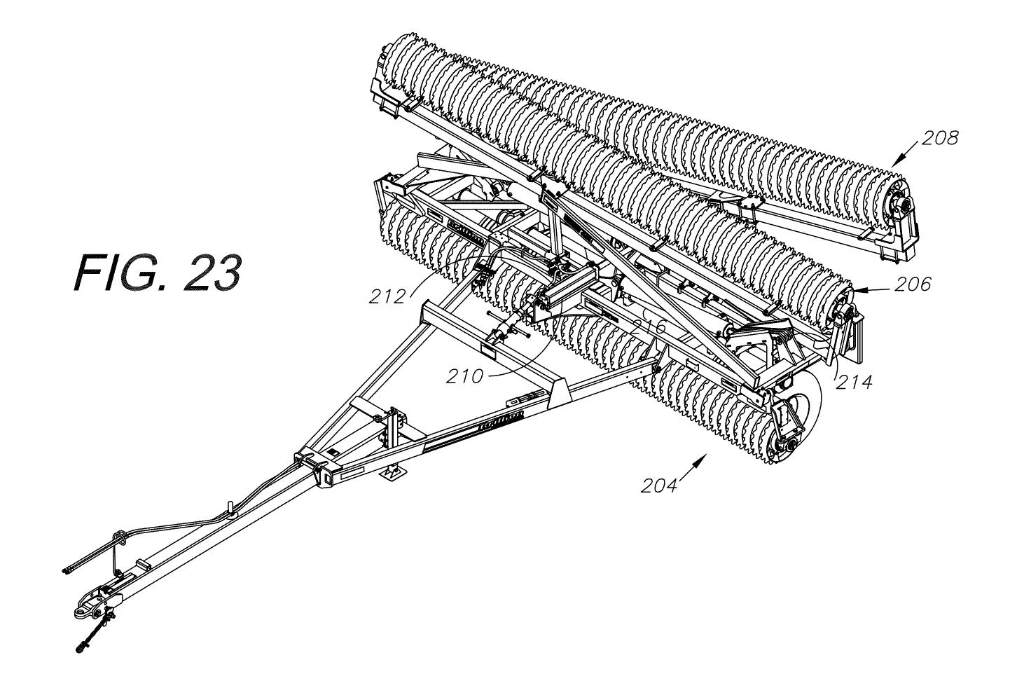

FIGS. 22, 23 show another alternative embodiment or aspect pulverizer 202 with a center section 204 mounting left and right wing sections 206, 208 which are adapted for pivoting and converting the pulverizer 202 to a narrower transport configuration as shown in FIG. 23. The pulverizer 202 includes a main lift assembly 210 with an hydraulic piston-and-cylinder unit 212. Wing lift assemblies 214 include respective piston-and-cylinder units 216, 218, which are adapted for raising and lowering the wing sections 206, 208 between field operating configurations (FIG. 22) and folded-wing, transport configurations (FIG. 23).

IV. Alternative Embodiment 330 with Multiple Rows of Ground-Working Tools and Arcuate Roller Slot

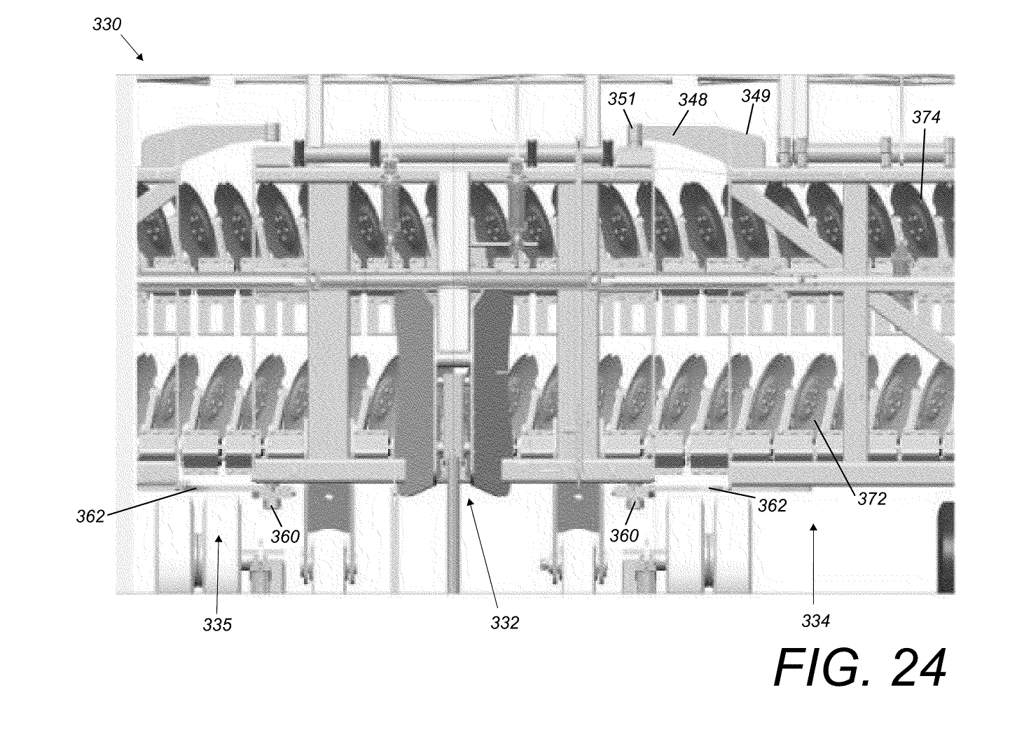

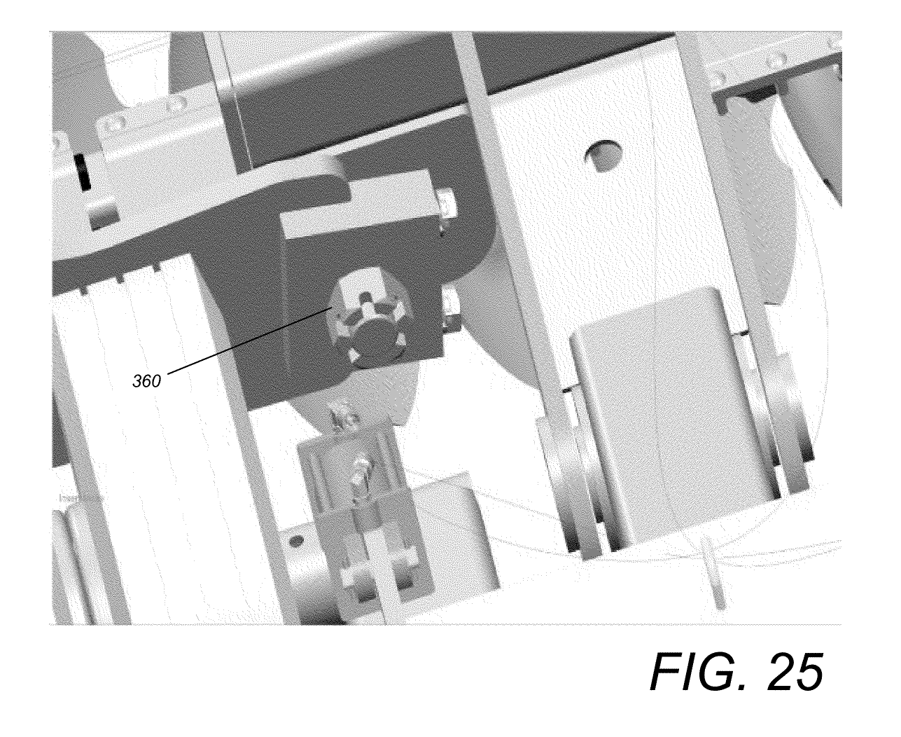

An alternative embodiment of an agricultural implement 330 having floatable wing sections 334, 335 is shown in FIGS. 24-26. In this embodiment, the agricultural implement 330 is configured for being towed behind a vehicle and includes a tool bar with a center section 332 and foldable wing sections 334, 335 on opposite sides of the center section 332. The implement 330 mounts a first row of coulter discs 372, or blades, a second row of coulter discs 374, or blades, and conditioning reels, or cylinders. The second row coulter discs 374 are mounted in an opposite direction from the front row coulter discs 372 for better conditioning of the soil. The wing sections 334, 335 in this embodiment are aligned next to the center section 332. The wing sections 334, 335 each connect to the center section 332 of the implement 330 via a ball joint 360 and a roller assembly 348 and roller slot 350. This configuration of a ball joint 360, roller assembly 348, and roller slot 350 allows the wings 334, 335 to float and conform to the contours of the soil, thus making contact with the maximum amount of workable ground.

Ball joints 360 allow for rotational movement about the ball joint in all directions. In this embodiment, a ball joint arm 362 is attached to the frame of each wing section 334, 335 of the implement 330. Each ball joint arm 362 includes a ball joint ball, and the ball joint ball connects to a ball joint socket, which is connected to the frame of the implement center section 332. A ball joint ball and ball joint socket connection forms each ball joint 360. The rotational movement about each ball joint 360 of this implement 330 is restricted by an arcuate roller slot 350. On the opposite end of the implement frame from each ball joint 360, arcuate roller slots 350 are mounted on the center section frame 332.

Each roller slot 350 is configured for receiving a guide roller 351. A roller assembly 348, made up of a guide roller 351 and a roller arm 349, is attached to each wing section frame 334, 335. The roller arm 349 connects to the wing section frame 334, 335 on the opposite end from the ball joint arm 362. In this embodiment, a guide roller 351 extends from each roller arm 349 into each roller slot 350 from the rear side. The guide rollers 351 and roller slots 350 allow the wing sections 334, 335 to float when being pulled over uneven ground. The roller slots 350 allow the guide rollers 351, and therefore the wings 334, 335, to assume a variety of orientations depending on ground conditions. FIG. 24 shows the implement 330 having its ball joints 360 connected to the leading end of the implement frame and the roller assemblies 348 and roller slots 350 connected to the trailing end of the implement frame. Alternatively, the locations of the ball joints 360 and the roller assemblies 348 and roller slots 350 could be swapped. Additionally, other types of universal joints may be used instead of ball joints.

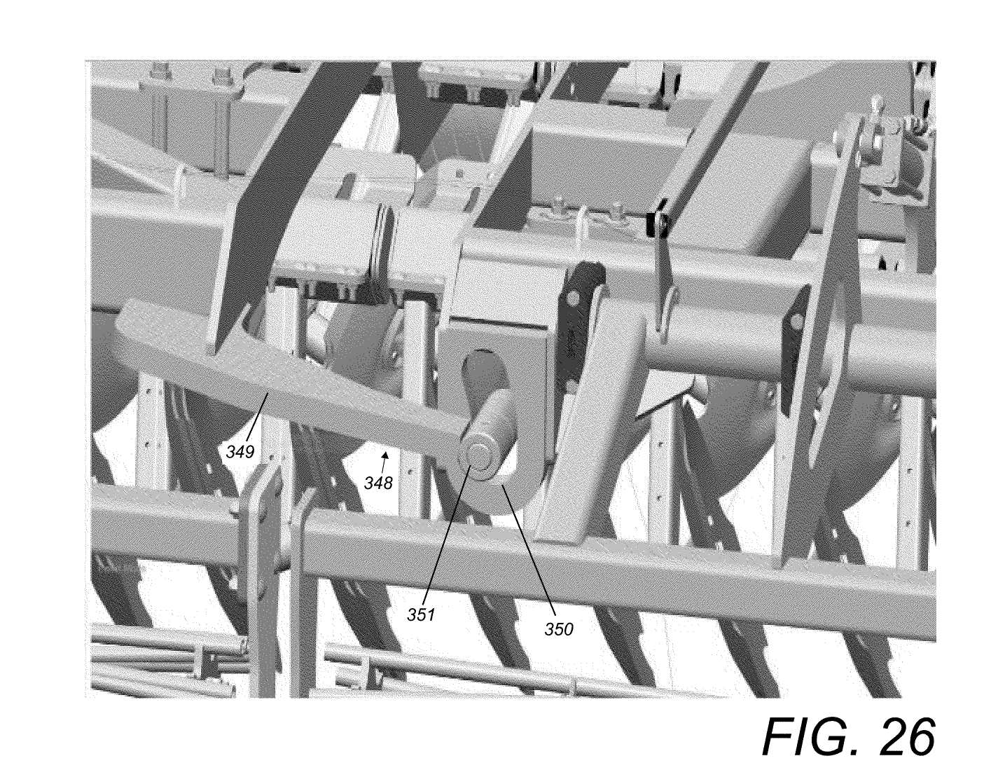

In this embodiment, as shown in FIG. 26, the roller slots 350 have an arcuate shape. The arcuate shape of roller slots 350 allows for more natural, less restricted movement of the wing sections 334, 335 when they are pulled over uneven ground and/or an obstruction.

In addition to allowing the implement 330 to better conform to the contours of the ground, floating wing sections prevent weight transfer from the wing sections 334, 335 to the center section 332, and vice versa. Thus, one section going over an obstacle, such as a rock, does not affect the rest of the implement, giving better efficiency.

When working ground having loose soil, floating wings may be undesirable. Loose soil underneath any part of the agricultural implement 330 may cause the guide rollers 351 to assume a variety of orientations within the roller slots 350 and cause the implement 330 to sink too deeply into the earth. To prevent the wings 334, 335 from floating, lockout kits 102, as described above, are configured for fitting within arcuate roller slots and can be used to lock the guide rollers 351 in place.

In alternative embodiments, this configuration of ball joints, roller assemblies, and roller slots and/or the arcuate configuration of roller slots can be applied to agricultural implements having different types of ground-working tools.

### V. Conclusion

The present invention also may be used on other agricultural implements with one or two center sections and two or more foldable wing sections on opposite sides of the one or two center sections.

It will be appreciated by persons skilled in the art that variations and/or modifications may be made to the present invention without departing from the spirit and scope of the invention. For example, the ball joint may be mounted toward the rear (rather than the front) of the center section, and the guide roller in roller slot may be mounted towards the front (rather than rear) of the center section. Further, the ball of the ball joint may be mounted on the wing section (rather than the center section), and the socket of the ball joint may be mounted on the center section (rather than on the wing section). Additionally, the guide roller slot may be mounted on the wing section (rather than the center section) and the guide roller may be mounted on the center section (rather than the wing section). In these various permutations, the wing will still fold and unfold about a longitudinal hinge axis, and still float about an orthogonal float axis.

Still further, the ball joint could be replaced by an assembly of plates and tubes to act as part of the folding hinge and provide a float axis as well; and, the guide roller in guide slot could be replaced by a combination of rollers to achieve the limited ambit of travel of the wing about the orthogonal float axis.

It is to be understood that while certain aspects of the disclosed subject matter have been shown and described, the disclosed subject matter is not limited thereto and encompasses various other embodiments and aspects.

Having this described the invention, what is claimed as new and desired to be secured by Letters Patent is:

1. An agricultural implement with a longitudinal axis and a direction of travel aligned with said longitudinal axis, which implement comprises:
a center section generally aligned with said longitudinal axis and including a center section frame, first and second edges, and opposite sides;
a pair of foldable wings each mounted on a respective opposite side of said center section, each wing having a wing frame, inboard and outboard sides, and first and second edges;
each said wing being hingedly connected at its inboard side to a respective center section side, each said wing being pivotable relative to said center section about a longitudinally-extending hinge axis between a folded, transport position over the center section and an unfolded, generally horizontal field position;
each said wing being universally, pivotally connected to said center section by a universal joint located at said first edges of said center section and wing frames and by a lost motion connection located at said second edges of said center section and wing frames;
each said universal joint and lost motion connection being positioned generally along a respective longitudinal hinge axis;
said lost motion connection comprising a guide roller and a slotted link, said link including a roller slot oriented generally vertically and including upper and lower ends;
said guide roller being mounted on one of said center section and a respective wing and said slotted link being mounted on the other of said center section and a respective wing;
said guide roller being configured for travel within said link between said slot upper and lower ends;
a pair of transverse wing float axes each extending through a respective universal joint, each said wing being pivotable at a respective universal joint about a respective wing float axis; and
each said guide roller in a respective roller slot accommodating limited rotational movement along a respective wing float axis relative to said center section.

2. The agricultural implement according to claim 1, wherein each said roller slot has an arcuate shape, said arcuate shapes of said slots being outwardly-convexly oriented.

3. The agricultural implement according to claim 1, further comprising:
a roller arm connected to said second edge of each said wing frame and connected to said guide roller; and
wherein said guide rollers are received within said roller slots from the back side.

4. The agricultural implement according to claim 1, wherein:
each said universal joint comprises a ball joint;
each said ball joint includes a ball joint ball and a ball joint socket;
each said ball joint socket is connected to said first edge of said center section frame;
said implement further comprises a ball joint arm connected to said first edge of each said wing frame and connected to said ball joint ball; and
said ball joint ball connects to said ball joint socket.

5. The agricultural implement according to claim 1, wherein:
said first edge of said center section frame comprises the leading edge of said center section frame;
said first edge of said wing frame comprises the leading edge of said wing frame;
said second edge of said center section frame comprises the trailing edge of said center section frame; and
said second edge of said wing frame comprises the trailing edge of said wing frame.

6. The agricultural implement according to claim 1, wherein:
said first edge of said center section frame comprises the trailing edge of said center section frame;
said first edge of said wing frame comprises the trailing edge of said wing frame;
said second edge of said center section frame comprises the leading edge of said center section frame; and
said second edge of said wing frame comprises the leading edge of said wing frame.

7. The agricultural implement according to claim 1, further comprising:
a lockout kit including a first and second end plate, a first and second stop, and a plurality of nuts and bolts joining said first and second end plates to said first and second stops; and
wherein said lockout kit is configured for placement within one of said roller slots to prevent movement of said guide roller within said roller slot.

8. An agricultural implement with a longitudinal axis and a direction of travel aligned with said longitudinal axis, which implement comprises:
a center section generally aligned with said longitudinal axis and including a center section frame, leading and trailing edges, and opposite sides;
a pair of foldable wings each mounted on a respective opposite side of said center section, each wing having a wing frame, inboard and outboard sides, and leading and trailing edges;
each said wing being hingedly connected at its inboard side to a respective center section side, each said wing being pivotable relative to said center section about a longitudinally-extending hinge axis between a folded, transport position over the center section and an unfolded, generally horizontal field position;
each said wing being universally, pivotally connected to said center section by a universal joint located at said leading edges of said center section and wing frames and by a lost motion connection located at said trailing edges of said center section and wing frames;
each said universal joint and lost motion connection being positioned generally along a respective longitudinal hinge axis;
said lost motion connection comprising a guide roller and a slotted link, said link including a roller slot oriented generally vertically and including upper and lower ends;
said guide roller being mounted on one of said center section and a respective wing, said slotted link being mounted on the other of said center section and a respective wing;
said guide roller being configured for travel within said link between said slot upper and lower ends;
a pair of transverse wing float axes each extending through a respective universal joint, each said wing being pivotable at a respective universal joint about a respective wing float axis;
each said guide roller in a respective roller slot accommodating limited rotational movement along a respective wing float axis relative to said center section;
wherein each said roller slot has an arcuate shape, said arcuate shapes of said slots being outwardly-convexly oriented;
a roller arm connected to said trailing edge of each said wing frame and connected to said guide roller;
wherein said guide rollers are received within said roller slots from the back side;
wherein each said universal joint comprises a ball joint;
wherein each said ball joint includes a ball joint ball and a ball joint socket;
wherein each said ball joint socket is connected to said leading edge of said center section frame;
a ball joint arm connected to said leading edge of each said wing frame and connected to said ball joint ball; and
wherein said ball joint ball connects to said ball joint socket.
